(19) United States
(12) Patent Application Publication
(10) Pub. No.: US 2009/0271106 A1
(43) Pub. Date: Oct. 29, 2009

(54) Navigation configuration for a motor vehicle, motor vehicle having a navigation system, and method for determining a route

(75) Inventors: Rohit Mishra, Mountain View, CA (US); Edward Kim, San Francisco, CA (US); Zhaoxia Zhang, Santa Clara, CA (US); Arati Gerdes, Palo Alto, CA (US)

Correspondence Address: MANFRED BECK PA, PO BOX 431255, SOUTH MIAMI, FL, 33243-1255, US

(73) Assignee: VOLKSWAGEN OF AMERICA, INC., Auburn Hills, MI (US)

(21) Appl. No.: 12/108,264

(22) Filed: Apr. 23, 2008

(51) Int. Cl. G01C 21/34; G06F 17/30

(52) U.S. Cl. 701/201

(57) ABSTRACT

A navigation configuration includes a microphone, disposed in a motor vehicle, for acoustically inputting a location designation. A server, disposed outside the motor vehicle, performs a speech recognition of an acoustically input location designation and converts the acoustically input location designation into a location designation of a database. A communication system transmits the acoustically input location designation from the motor vehicle to the server and transmits the location designation of the database from the server to the motor vehicle. A navigation system, disposed in the motor vehicle, determines a route from a location of the motor vehicle to a destination as a function of the location designation of the database. A motor vehicle having a navigation system for determining a route and a method for determining a route from a location of the motor vehicle to a destination are also provided.

### BACKGROUND OF THE INVENTION

### Field of the Invention

The invention relates to a navigation configuration for determining the route from a location of a motor vehicle to a destination, wherein the navigation configuration includes a navigation system, disposed in the motor vehicle, for determining the route as a function of a location designation. The invention also relates to a motor vehicle having a navigation system for determining the route from a location of the navigation system to a destination as a function of a location designation. The invention also relates to a method for determining the route from a location of a motor vehicle to a destination, wherein the determination of the route is carried out as a function of a location designation.

Navigation systems for motor vehicles are disclosed, for example, in the periodical autoconnect 2005, Vereinigte Motor-Verlage GmbH & Co. KG (United Motor Publishing House, Inc.), Leuschnerstr. 1, 70174 Stuttgart, Germany.

### SUMMARY OF THE INVENTION

It is an object of the invention to provide a navigation configuration for a motor vehicle, a motor vehicle having a navigation system and a method for determining a route which simplify the operator control of a navigation system in a motor vehicle.

With the foregoing and other objects in view there is provided, in accordance with the invention, a navigation configuration including:

a microphone, disposed in a motor vehicle, for acoustically inputting a location designation;

a server, disposed outside the motor vehicle, for performing a speech recognition of an acoustically input location designation and for converting the acoustically input location designation into a location designation of a database;

a communication system for transmitting the acoustically input location designation from the motor vehicle to the server and for transmitting the location designation of the database from the server to the motor vehicle; and

a navigation system, disposed in the motor vehicle, for determining a route from a location of the motor vehicle to a destination as a function of the location designation of the database.

According to another feature of the invention, the communication system is configured as a wireless Internet connection.

According to a further feature of the invention, the location designation of the database can be confirmed.

According to another feature of the invention, the location designation of the database can include at least a selection from two location designations, wherein one of the two locations designations can be selected.

According to yet another feature of the invention, the motor vehicle includes an on-board speech recognition.

According to another feature of the invention, the on-board speech recognition is configured to recognize an acoustic instruction for confirming the location designation of the database.

According to another feature of the invention, the location designation of the database can include at least a list of two location designations, wherein one of the two location designations can be selected, and wherein the on-board speech recognition is configured to recognize an acoustic instruction for selecting one of the two location designations from the list.

In other words, according to the invention, the above-mentioned object is achieved by a navigation configuration for determining the route from a location of a motor vehicle to a destination, wherein the navigation configuration includes a microphone, disposed in the motor vehicle, for acoustically inputting a location designation, a server, disposed outside the motor vehicle, for performing speech recognition of the acoustically input location designation and for converting it into a location designation from/of a database and/or into a graphic location designation, a communication system for transmitting the acoustically input location designation from the motor vehicle to the server and for transmitting the location designation from/of the database from the server to the motor vehicle, and a navigation system, disposed in the motor vehicle, for determining the route as a function of the location designation from/of the database and/or the graphic location designation. In particular a speech recognition process, through the use of which the acoustic location designation is converted into a designation with which the entries (location designations) of a database can be compared, is performed here through the use of the server. When there is correspondence or a specific degree of correspondence, the corresponding entry is transmitted as “location designation from/of the database” to the motor vehicle. A location designation from/of the database within the meaning of the invention can include a graphic location designation and/or an acoustic location designation. A graphic location designation within the meaning of the invention can include alphanumeric code, text, scripts, videos and/or images. A location designation from/of the database within the meaning of the invention can include a list of a plurality of possible location designations.

In accordance with an embodiment of the invention, the communication system is configured as a wireless Internet connection. A wireless Internet connection within the meaning of the invention is an Internet connection which includes a wireless communication path. The wireless communication path relates in particular to a wireless connection from the motor vehicle to a locationally fixed node. In a further embodiment of the invention, the location designation from/of the database can be confirmed. In a further embodiment of the invention, the location designation from/of the database and/or the graphic location designation includes at least a selection from two location designations, one of which can be selected. In a further embodiment of the invention, the motor vehicle includes an on-board speech recognition. In a further embodiment of the invention, an acoustic instruction for confirming the location designation from/of the database and/or the graphic location designation can be recognized by the on-board speech recognition. In a further embodiment of the invention, the location designation from/of the database and/or the graphic location designation includes at least a list of two location designations, one of which can be selected, and wherein an acoustic instruction for selecting one of the at least two location designations from the list can be recognized by the on-board speech recognition.

With the objects of the invention in view there is also provided, a motor vehicle including:

a microphone for acoustically inputting a location designation;

a transmitter device configured to transmit an acoustically input location designation to a server disposed outside the motor vehicle, for the purpose of speech recognition and for conversion of the acoustically input location designation into a location designation of a database;

a receiver device for receiving the location designation of the database from the server; and

a navigation system for determining a route from a location of the navigation system to a destination as a function of the location designation of the database.

According to another feature of the invention, the location designation of the database can be confirmed.

According to a further feature of the invention, the location designation of the database can include at least a selection from two location designations, wherein one of the two locations designations can be selected.

According to another feature of the invention, the motor vehicle has an on-board speech recognition.

According to yet another feature of the invention, the on-board speech recognition is configured to recognize an acoustic instruction for confirming the location designation of the database.

According to another feature of the invention, the location designation of the database can include at least a list of two location designations, wherein one of the two location designations can be selected, and wherein the on-board speech recognition is configured to recognize an acoustic instruction for selecting one of the two location designations from the list.

In other words, the above-mentioned object is additionally achieved through the use of a motor vehicle, wherein the motor vehicle includes a microphone for acoustically inputting a location designation, a transmitter device for transmitting the acoustically input location designation to a server, disposed outside the motor vehicle, for performing a speech recognition of the acoustically input location designation and for converting it into a location designation from/of a database and/or into a graphic location designation, a receiver device for receiving the graphic location designation from the server, and a navigation system for determining the route from a location of the navigation system to a destination as a function of the location designation from/of the database and/or the graphic location designation. In particular a speech recognition process through the use of which the acoustic location designation is converted into a designation with which the entries (location designations) of a database can be compared is carried out through the use of the server. When there is correspondence or a certain degree of correspondence, the corresponding entry is transmitted as “location designation from/of the database” to the motor vehicle. A location designation from/of the database within the meaning of the invention can include a graphic location designation and/or an acoustic location designation. A graphic location designation within the meaning of the invention can include alphanumeric code, text, scripts, videos and/or images. A location designation from/of the database within the meaning of the invention can include a list of a plurality of possible location designations.

In an embodiment of the invention, the location designation from/of the database and/or the graphic location designation can be confirmed. In a further embodiment of the invention, the location designation from/of the database and/or the graphic location designation can include at least a selection of two location designations, one of which can be selected. In a further embodiment of the invention, the motor vehicle also includes an on-board speech recognition. In a further embodiment of the invention, an acoustic instruction for confirming the location designation from/of the database and/or the graphic location designation can be recognized by the on-board speech recognition. In a further embodiment of the invention, the location designation from/of the database and/or the graphic location designation can include at least a list of two location designations, one of which can be selected, and wherein an acoustic instruction for selecting one of the at least two location designations from the list can be recognized by the on-board speech recognition.

With the objects of the invention in view there is also provided, a method for determining a route from a location of a motor vehicle to a destination that includes the step of:

acoustically recording a location designation within a motor vehicle;

transmitting an acoustically recorded location designation to a server disposed outside the motor vehicle;

converting the acoustically recorded location designation into a location designation of a database by using the server;

transmitting the location designation of the database from the server;

receiving the location designation of the database in the motor vehicle; and

determining a route from a location of the motor vehicle to a destination as a function of the location designation of the database.

Another mode of the method according to the invention includes selecting, if the location designation of the database includes a list of at least two location designations, a location designation from the list before determining the route.

A further mode of the method according to the invention includes selecting the location designation from the list by evaluating an acoustic instruction.

Another mode of the method according to the invention includes evaluating the acoustic instruction by using an on-board speech recognition disposed within the motor vehicle.

In other words, the above-mentioned object is additionally achieved through the use of a method for determining the route from a location of a motor vehicle to a destination, wherein the method includes the steps of an acoustic recording of a location designation within the motor vehicle; a transmission of the acoustically recorded location designation to a server disposed outside the motor vehicle; a conversion of the acoustically recorded location designation into a location designation from/of a database and/or a graphic location designation through the use of the server; a transmission of the location designation from/of the database and/or the graphic location designation from the server; a reception of the location designation from/of the database and/or the graphic location designation in the motor vehicle; and a determination of the route as a function of the location designation from/of the database and/or the graphic location designation. In this context in particular a speech recognition process through the use of which the acoustic location designation is converted into a designation with which the entries (location designations) of a database can be compared is carried out through the use of the server. When there is correspondence or a certain degree of correspondence, the corresponding entry is transmitted as a “location designation from/of the database” to the motor vehicle. A location designation from/of the database within the meaning of the invention can include a graphic location designation and/or an acoustic location designation. A graphic location designation within the meaning of the invention can include alphanumeric code, text, scripts, videos and/or images. A location designation from/of the database within the meaning of the invention can include a list of a plurality of possible location designations.

In an embodiment of the invention, insofar as the location designation from/of the database and/or the graphic location designation includes a list of at least two location designations, a selection of a location designation from the list is carried out before the determination of the route. In a further embodiment of the invention, the selection of a location designation from the list is carried out by evaluating an acoustic instruction. In a further embodiment of the invention, the evaluation of an acoustic instruction is carried out by an on-board speech recognition disposed within the motor vehicle. A motor vehicle within the meaning of the invention is in particular a land vehicle which can be used individually in road traffic. Motor vehicles within the meaning of the invention are, in particular, not restricted to land vehicles with an internal combustion engine.

Other features which are considered as characteristic for the invention are set forth in the appended claims.

Although the invention is illustrated and described herein as embodied in a navigation configuration for a motor vehicle, a motor vehicle having a navigation system, and a method for determining a route, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic overview of an exemplary embodiment of a navigation configuration for a motor vehicle according to the invention;

FIG. 2 is a basic schematic view of an exemplary embodiment of a motor vehicle having a navigation system according to the invention; and

FIG. 3 is a flow chart for illustrating an exemplary embodiment of a method for assisting in the navigation of a motor vehicle in accordance with the invention.

### DESCRIPTION OF THE PREFERRED EMBODIMENTS

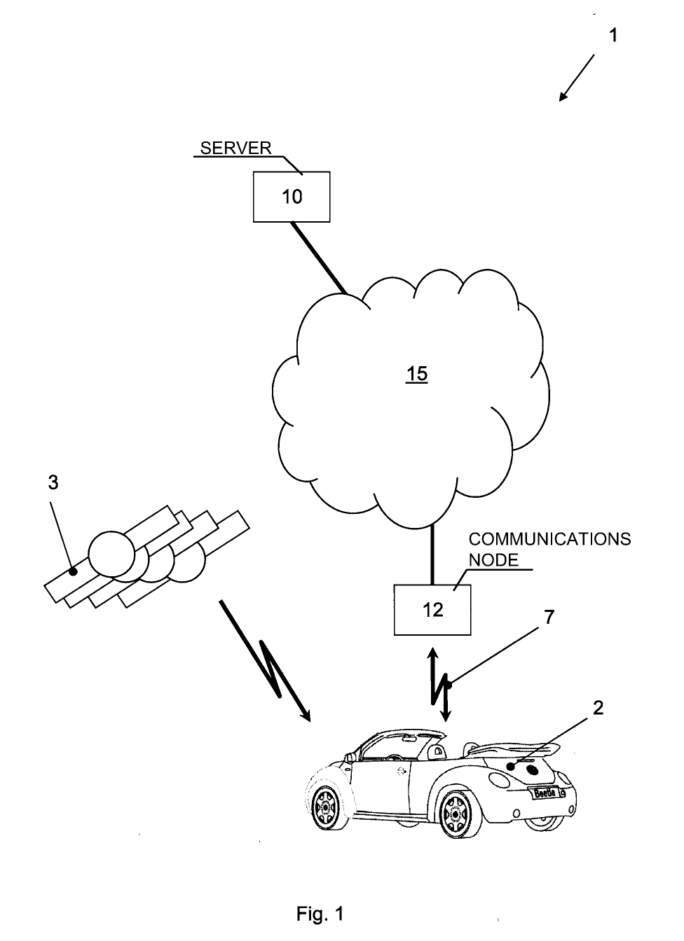

Referring now to the figures of the drawings in detail and first, particularly, to FIG. 1 thereof, there is shown a navigation configuration 1 for determining a route from a location of a motor vehicle 2 to a destination. The navigation configuration 1 includes a server 10, disposed outside the vehicle 2, for performing speech recognition of an acoustically input location destination and for converting it into a location designation from/of a database. The navigation configuration 1 also includes a wireless Internet connection between the motor vehicle 2 and the server 10 via which an acoustically input location designation is transmitted from the motor vehicle 2 to the server 10, and a corresponding location designation, which has been determined by the server 10 and corresponds to the acoustically input location designation from/of the database is transmitted from the server 10 to the motor vehicle 2. In order to implement the wireless Internet connection, a wireless communications connection 7 is provided between the motor vehicle 2 and a communications node 12 for connection to the Internet 15. The wireless communications connection 7 is in particular a WLAN (wireless local area network). However, it is also possible to provide that a wireless communications connection 7 is implemented as a WIFI connection, WIMAXI connection, RFI connection, mobile radio connection, etc. It is also possible to provide that, depending on specific criteria, a selection is made (automatically) between alternative wireless communications connections. These criteria are, for example, costs, availability and/or bandwidth, etc.

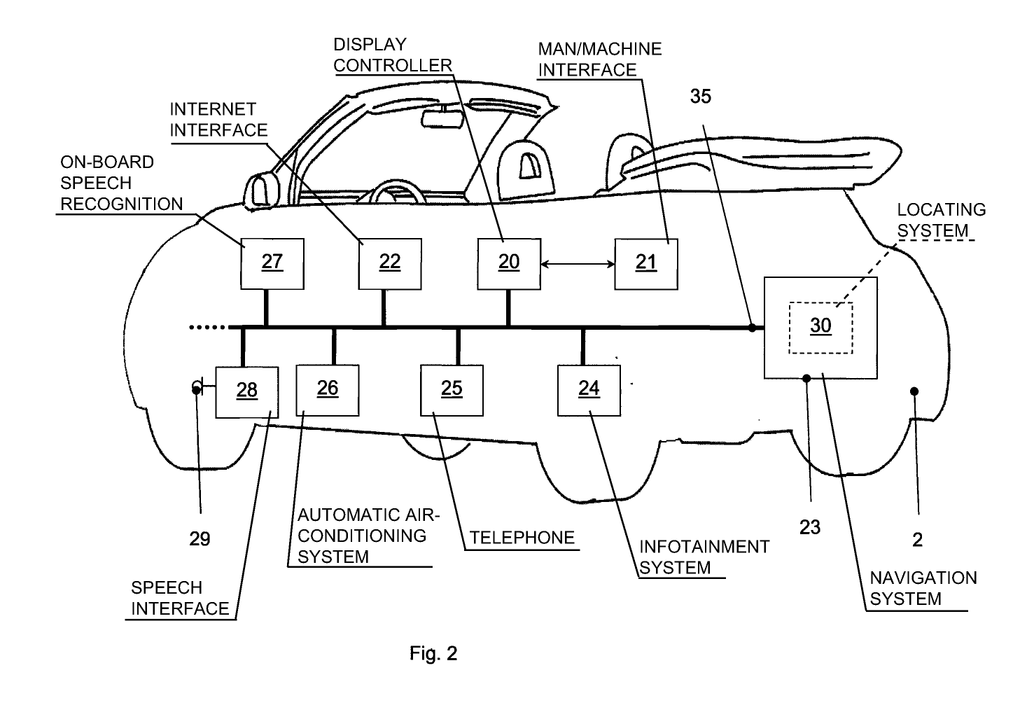

FIG. 2 shows an exemplary embodiment of an exemplary implementation of the motor vehicle 2 in a basic illustration. The motor vehicle 2 includes a man/machine interface 21, configured for example as a touchscreen, for outputting the route proposal to an operator of the motor vehicle 2. For this purpose, the touchscreen 21 can be activated through the use of a display controller 20 which is connected through the use of a bus system 35 to an Internet interface 22 for the wireless communications connection 7. The man/machine interface 21, configured as a touchscreen, can, according to the present exemplary embodiment, also be used for the operator control of an Infotainment system 24, a telephone 25 or an automatic air-conditioning system 26.

The motor vehicle 2 includes a locating system 30, integrated into a navigation system 23, for determining the position of the motor vehicle 2, the orientation of the motor vehicle 2 and/or the on-board time as a function of signals which are transmitted by satellites designated by reference symbol 3 in FIG. 1. A route proposal for the motor vehicle 2 to a destination can be obtained through the use of the navigation system 23.

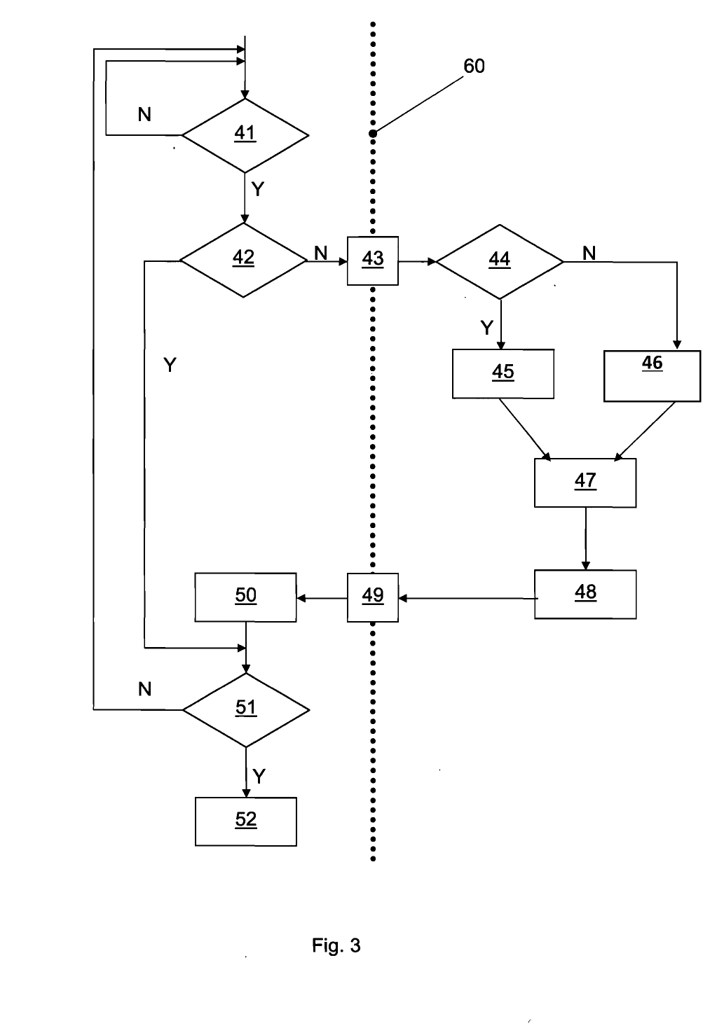

The motor vehicle 2 also includes a microphone 29 which is coupled to the bus system 35 via a speech interface 28. It is also possible to provide a loudspeaker, which can also be coupled to the bus system 35 via the speech interface 28. An acoustic input of a location designation for the navigation system 23 can be made through the use of the microphone 29 in conjunction with the speech interface 28. This acoustic input can be evaluated by an on-board speech recognition 27, or as described below with reference to FIG. 3, through the use of the server 10.

FIG. 3 shows an exemplary embodiment of a method for assisting in the navigation of a motor vehicle or for operating the navigation configuration 1. Here, the dashed line designated by reference symbol 60 in FIG. 3 between the motor vehicle 2 and the server 10 designates how interrogations and the steps are assigned. The interrogations and the steps which are assigned to the motor vehicle 2 are illustrated to the left of the dashed line 60, and the interrogations and steps which are assigned to the server 10 are illustrated to the right of the dashed line 60.

The method illustrated in FIG. 3 starts with an interrogation 41 as to whether a valid speech input occurs. A valid speech input in this sense will be a speech input which takes place at a time at which a speech input is intended or planned for the navigation system. If a valid speech input occurs, the interrogation 41 is followed by an interrogation 42 as to whether the speech input can be evaluated by the on-board speech recognition 27. If the speech input cannot be carried out by on-board speech recognition 27, the interrogation 42 is followed by a step 43. In the step 43, the speech input is converted into an Internet-compatible format and is transmitted to the IP (Internet Protocol) address of the server 10. Moreover, in the step 43, the position of the motor vehicle 2 is transmitted and information indicating whether a destination has already been selected for a route or a route has been selected.

In addition, in the step 43, the speech input is received by the server. The step 43 is followed by an interrogation 44 as to whether a destination for a route has been defined or a route has been defined. If there has been no definition of a destination or route, in a step 46 a database is loaded in a radius around the location of the motor vehicle 2. Otherwise, in a step 45 a database is loaded in a corridor along the route. The steps 45 and 46 are followed by a step 47 in which speech recognition of the acoustic input is carried out. The step 47 is followed by a step 48 in which the acoustic input which is converted in the step 47 is evaluated. Within the scope of this evaluation, the result of the speech recognition which is carried out in the step 47 is compared with entries (location designations) of the database (defined in steps 45 and 46). If the input corresponds to an entry of the database (defined in steps 45 or 46), or if it corresponds at least to a certain degree to the entry in the database, this entry is retained as a result. The result is an exemplary embodiment of a location designation from/of the database within the meaning of the claims. If a result is not achieved in this way, the input can also be fed to a search engine.

The step 48 is followed by a step 49 in which the result “location designation from/of the database” is transmitted from the server 10 to the motor vehicle. The step 49 is followed by a step 50 by the result “location designation from/of the database” being output in the motor vehicle 2. This can be done, for example, through the use of the touchscreen 21 and/or through the use of an acoustic output. If the result “location designation from/of the database” contains a plurality of entries, these are displayed through the use of the touchscreen 21 and/or output acoustically. If the location designation from/of the database includes just one entry, it has to be confirmed. If the inputting of the location designation from/of the database includes a plurality of entries, one of these entries is to be selected. In the event of a display on the touchscreen, this can be done, for example, by touching the touchscreen at a corresponding location.

After selection or confirmation of an entry of the location designation from/of the database, the step 50 is followed by a step 52 by virtue of the fact that the route is calculated as a function of this entry. This can be done, for example, by using the entry as a destination of a route or as an intermediate destination or intermediate stop. If acoustic confirmation or selection of an entry of the location designation from/of the database is provided, the step 50 is followed by an interrogation 51 as to whether the last acoustic input was an instruction for confirming or selecting. If the last speech input was an instruction for confirming or selecting an entry of the location designation from/of the database, the interrogation 51 is followed by the step 52. Otherwise, the interrogation 51 is followed by the interrogation 41.

If an acoustic output is provided, a grapheme-to-phoneme function which is provided for this purpose can be implemented in the vehicle or on the server 10. Details of a grapheme-to-phoneme function can be found, for example, in the article “Grapheme-to-phoneme conversion, a knowledge-based approach” by Niklas Torstensson, Dept. of Languages, Högskolan i Skövde, TMH-QPSR Vol. 44-Fonetik 2002 on the Internet page www.speech.kth.se/qpsr/tmh/2002/02-44-117-120.pdf. If the grapheme-to-phoneme function takes place on the server 10, the result “location designation from/of the database” is converted by the server 10 into a phoneme through the use of a grapheme-to-phoneme function and is transmitted as such to the motor vehicle.

In the present exemplary embodiment there is provision that the on-board speech recognition is provided only for recognizing instructions. If an acoustic input is detected by the on-board speech recognition, this is therefore an instruction in the present exemplary embodiment. In this case, the interrogation 42 is followed by the interrogation 51. If this instruction is suitable for selecting or confirming an input (cf. step 50), the interrogation 51 is followed by the step 52.

The navigation configuration 1 and the method illustrated in FIG. 3 are explained once more below with reference to an example. If, for example, a speech input “Pizza Chicago” is made, this input is transmitted through the use of TCP (Transmission Control Protocol) or HTTP (Hypertext Transfer Protocol) to the server 10. The result which is determined by the server 10 with respect to the speech input “Pizza Chicago” is transmitted, for example in the form of XML (Extensible Markup Language) formatted data, from the server 10 to the motor vehicle 2. The result can include, for example, pizzerias and Italian restaurants in Chicago as well as pizzerias and Italian restaurants with the name “Chicago.”

The system according to the invention makes it possible to simplify significantly the operator control of a navigation system. In this context, the computing power of a server and the size of the database used by it permits a particularly reliable acoustic input without a system having to be trained to a user's voice. Furthermore, the invention has the following further advantages. For example, the invention permits searching for entries which are not stored in a system implemented in a motor vehicle but rather on other platforms. Such data may be more up-to-date and have a greater relevance than data which can be implemented in a factory-installed system. Furthermore, the invention permits, for example, access to relatively large pronunciation libraries. A further advantage is the computing speed or power of a locationally fixed server compared to a system which is implemented in a motor vehicle.

### LIST OF REFERENCE NUMERALS

1 Navigation configuration
2 Motor vehicle
3 Satellite
7 Communications connection
10 Server
12 Communications node
15 Internet
16 Terminal
20 Display controller
21 Configured man/machine interface
22 Internet interface
23 Navigation system
24 Infotainment system
25 Telephone
26 Automatic air-conditioning system
27 On-board speech recognition
28 Speech interface
29 Microphone
30 Locating system
35 Bus system
41, 42, 44, 51 Interrogation
43, 45, 46, 47 Interrogation
48, 49, 50, 52 Step
60 Line

What is claimed is:

1. A navigation configuration comprising:
a microphone, disposed in a motor vehicle, for acoustically inputting a location designation;
a server, disposed outside said motor vehicle, for performing a speech recognition of an acoustically input location designation and for converting the acoustically input location designation into a location designation of a database;
a communication system for transmitting the acoustically input location designation from said motor vehicle to said server and for transmitting the location designation of said database from said server to said motor vehicle; and
a navigation system, disposed in said motor vehicle, for determining a route from a location of said motor vehicle to a destination as a function of the location designation of said database.

2. The navigation configuration according to claim 1, wherein said communication system is configured as a wireless Internet connection.

3. The navigation configuration according to claim 1, wherein the location designation of said database can be confirmed.

4. The navigation configuration according to claim 1, wherein the location designation of said database can include at least a selection from two location designations, wherein one of the two locations designations can be selected.

5. The navigation configuration according to claim 1, wherein said motor vehicle includes an on-board speech recognition.

6. The navigation configuration according to claim 5, wherein said on-board speech recognition is configured to recognize an acoustic instruction for confirming the location designation of the database.

7. The navigation configuration according to claim 5, wherein the location designation of said database can include at least a list of two location designations, wherein one of the two location designations can be selected, and wherein said on-board speech recognition is configured to recognize an acoustic instruction for selecting one of the two location designations from the list.

8. A motor vehicle comprising:
a microphone for acoustically inputting a location designation;
a transmitter device configured to transmit an acoustically input location designation to a server disposed outside the motor vehicle, for the purpose of speech recognition and for conversion of the acoustically input location designation into a location designation of a database;
a receiver device for receiving the location designation of the database from said server; and
a navigation system for determining a route from a location of said navigation system to a destination as a function of the location designation of said database.

9. The motor vehicle according to claim 8, wherein the location designation of said database can be confirmed.

10. The motor vehicle according to claim 8, wherein the location designation of said database can include at least a selection from two location designations, wherein one of the two locations designations can be selected.

11. The motor vehicle according to claim 8, including an on-board speech recognition.

12. The motor vehicle according to claim 11, wherein said on-board speech recognition is configured to recognize an acoustic instruction for confirming the location designation of said database.

13. The motor vehicle according to claim 11, wherein the location designation of said database can include at least a list of two location designations, wherein one of the two location designations can be selected, and wherein said on-board speech recognition is configured to recognize an acoustic instruction for selecting one of the two location designations from the list.

14. A method for determining a route from a location of a motor vehicle to a destination, the method which comprises:
acoustically recording a location designation within a motor vehicle;
transmitting an acoustically recorded location designation to a server disposed outside the motor vehicle;
converting the acoustically recorded location designation into a location designation of a database by using the server;
transmitting the location designation of the database from the server;
receiving the location designation of the database in the motor vehicle; and
determining a route from a location of the motor vehicle to a destination as a function of the location designation of the database.

15. The method according to claim 14, which comprises selecting, if the location designation of the database includes a list of at least two location designations, a location designation from the list before determining the route.

16. The method according to claim 15, which comprises selecting the location designation from the list by evaluating an acoustic instruction.

17. The method according to claim 16, which comprises evaluating the acoustic instruction by using an on-board speech recognition disposed within the motor vehicle.
